(19) United States
(12) Patent Application Publication
(10) Pub. No.: US 2025/0106707 A1
(43) Pub. Date: Mar. 27, 2025

(54) METHOD FOR WIRELESS COMMUNICATION AND TERMINAL DEVICE

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN); Zuomin WU, Dongguan (CN)

(21) Appl. No.: 18/965,532

(22) Filed: Dec. 2, 2024

Related U.S. Application Data
(63) Continuation of application No. PCT/CN2023/121226, filed on Sep. 25, 2023.

(51) Int. Cl. H04W 36/00; H04W 36/08; H04W 84/06

(52) U.S. Cl. CPC H04W 36/0072; H04W 36/083; H04W 84/06

(57) ABSTRACT

A wireless communication method and a terminal device are provided. The method includes: determining, by a terminal device based on a first condition, whether to use a first timing parameter, where the first timing parameter is a timing parameter provided by a first cell, and the first condition is associated with one or more of following: information associated with cell handover of the terminal device; an instant at which the first cell stops serving the terminal device; or a location of the terminal device.

### CROSS-REFERENCE TO RELATED APPLICATIONS

This application is a continuation of International Application No. PCT/CN2023/121226, filed on Sep. 25, 2023, the disclosure of which is hereby incorporated by reference in its entirety.

### TECHNICAL FIELD

This application relates to the field of communications technologies, and more specifically, to a method for wireless communication and a terminal device.

### BACKGROUND

An offset parameter (or may also be referred to as a timing parameter) is introduced into related technologies to enhance a timing sequence in an NTN system. In this case, how a terminal device determines validity of the offset parameter or how the terminal device uses the offset parameter becomes a problem to be solved.

### SUMMARY

This application provides a method for wireless communication and a terminal device. The following describes the aspects related to this application.

According to a first aspect, a wireless communication method is provided, and the method includes: determining, by a terminal device based on a first condition, whether to use a first timing parameter, where the first timing parameter is a timing parameter provided by a first cell, and the first condition is associated with one or more of the following: information associated with cell handover of the terminal device; an instant at which the first cell stops serving the terminal device; or a location of the terminal device.

According to a second aspect, a terminal device is provided, and the terminal device includes: a determining unit, configured to determine, based on a first condition, whether to use a first timing parameter, where the first timing parameter is a timing parameter provided by a first cell, and the first condition is associated with one or more of the following: information associated with cell handover of the terminal device; an instant at which the first cell stops serving the terminal device; or a location of the terminal device.

According to a third aspect, a terminal device is provided, including a processor, a memory, and a communications interface, where the memory is configured to store one or more computer programs, and the processor is configured to invoke the computer program in the memory, to cause the terminal device to execute some or all of the steps in the method according to the first aspect.

According to a fourth aspect, an embodiment of this application provides a communications system, where the system includes the foregoing terminal device. In another possible design, the system may further include another device that interacts with the terminal device in the solution provided in embodiments of this application.

According to a fifth aspect, an embodiment of this application provides a computer-readable storage medium, where the computer-readable storage medium stores a computer program, and the computer program causes a terminal to perform some or all of the steps in the method according to the first aspect.

According to a sixth aspect, an embodiment of this application provides a computer program product, where the computer program product includes a non-transitory computer-readable storage medium that stores a computer program, and the computer program is operable to cause a terminal to perform some or all of the steps of the method according to the first aspect. In some implementations, the computer program product may be a software installation package.

According to a seventh aspect, a computer program is provided, where the computer program causes a computer to execute the method according to the first aspect.

According to an eighth aspect, an embodiment of this application provides a chip, where the chip includes a memory and a processor, and the processor may invoke a computer program from the memory and run the computer program, to implement some or all of the steps described in the method according to the first aspect.

### BRIEF DESCRIPTION OF DRAWINGS

FIG. 1 shows a wireless communications system to which an embodiment of this application is applied.

FIG. 2A is an example diagram of an uplink transmission delay in a case that there is no TA mechanism.

FIG. 2B is an example diagram of an uplink transmission delay in a case where there is a TA mechanism.

FIG. 3 is a schematic diagram of a timing relationship in an NTN system.

FIG. 4 is a schematic diagram of another timing relationship in an NTN system.

FIG. 5 is a schematic flowchart of a method for wireless communication according to an embodiment of this application.

FIG. 6 is a schematic diagram of a terminal device according to an embodiment of this application.

FIG. 7 is a schematic diagram of a structure of a communications apparatus according to an embodiment of this application.

### DESCRIPTION OF EMBODIMENTS

The technical solutions in this application are described below with reference to the accompanying drawings. For a better understanding of this application, a communications system to which an embodiment of this application is applied is first described below with reference to FIG. 1.

FIG. 1 shows a wireless communications system 100 to which an embodiment of this application is applied. The wireless communications system 100 may include a network device 110 and terminal devices 120. The network device 110 may be a device that communicates with the terminal device 120. The network device 110 may provide communication coverage for a specific geographic area, and may communicate with the terminal device 120 located within the coverage.

FIG. 1 exemplarily shows one network device and two terminals. Optionally, the wireless communications system 100 may include a plurality of network devices, and another quantity of terminal devices may be included in coverage of each network device, which is not limited in embodiments of this application.

Optionally, the wireless communications system 100 may further include another network entity such as a network controller or a mobility management entity, which is not limited in embodiments of this application.

It should be understood that the technical solutions of embodiments of this application may be applied to various communications systems, such as a 5th generation (5G) system or new radio (NR), a long-term evolution (LTE) system, an LTE frequency division duplex (FDD) system, and LTE time division duplex (TDD). The technical solutions provided in this application may further be applied to a future communications system, such as a 6th generation mobile communications system or a satellite communications system.

The terminal device in embodiments of this application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device or a vehicle-mounted device having a wireless connection function. The terminal device in embodiments of this application may be a mobile phone (mobile phone), a tablet computer (Pad), a notebook computer, a palmtop computer, a mobile internet device (MID), a wearable device, a virtual reality (VR) device, an augmented reality (AR) device, a wireless terminal in industrial control (industrial control), a wireless terminal in self driving (self driving), a wireless terminal in remote medical surgery (remote medical surgery), a wireless terminal in smart grid (smart grid), a wireless terminal in transportation safety (transportation safety), a wireless terminal in smart city (smart city), a wireless terminal in smart home (smart home), or the like. Optionally, the UE may function as a base station. For example, the UE may function as a scheduling entity, which provides a sidelink signal between UEs in V2X, D2D, or the like. For example, a cellular phone and a vehicle communicate with each other through a sidelink signal. A cellular phone and a smart home device communicate with each other, without relaying a communication signal by using a base station.

The network device in embodiments of this application may be a device configured to communicate with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover various names in the following, or may be replaced with a name in the following, for example, a NodeB (NodeB), an evolved NodeB (eNB), a next generation NodeB (gNB), a relay station, an access point, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (V2X), and machine-to-machine (M2M) communication, a network-side device in a 6G network, a device that functions as a base station in a future communications system, or the like. The base station may support networks with a same access technology or different access technologies. A specific technology and a specific device used by the network device are not limited in embodiments of this application.

The base station may be fixed or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device that communicates with another base station.

In some deployments, the network device in embodiments of this application may be a CU or a DU, or the network device includes a CU and a DU. The gNB may further include an AAU.

The network device and the terminal device may be deployed on land, including being deployed indoors or outdoors, handheld, or vehicle-mounted, may be deployed on a water surface, or may be deployed on a plane, a balloon, or a satellite in the air. In embodiments of this application, a scenario in which the network device and the terminal device are located is not limited.

It should be understood that all or some of functions of a communications device in this application may also be implemented by software functions running on hardware, or by virtualization functions instantiated on a platform (for example, a cloud platform).

For ease of understanding, related concepts and communication processes involved in embodiments of this application are described below.

At present, with a demand for speed, delay, high-speed mobility, and energy efficiency, as well as diversity and complexity of services in future life, the 3GPP international standards organization starts to develop 5G. Main scenarios for 5G include: enhanced mobile broadband (eMBB), ultra-reliable low latency communications (URLLC), and massive machine type communications (mMTC).

The eMBB aims to provide a user with access to multimedia content, services, and data. The demand for eMBB grows rapidly. In addition, since eMBB may be deployed in different scenarios, such as indoor, urban, or rural areas, its capabilities and requirements vary greatly. Therefore, applying a same standard to all is impractical, and a detailed analysis needs to be conducted with reference to a specific deployment scenario. Typical applications of URLLC include industrial automation, electric power automation, remote medical operations (surgery), traffic safety guarantee, and the like. Typical features of mMTC include high connection density, small data volume, delay-insensitive services, low costs and long service life of modules.

NR may also be deployed independently. In a 5G network environment, in order to reduce air interface signaling, quickly restore a wireless connection, and quickly restore a data service, a new RRC state, namely, an RRC inactive state (RRC_INACTIVE), is defined. This state is different from an RRC idle state (RRC_IDLE) and an RRC activated state (RRC_ACTIVE). The following describes the three states.

The RRC connected state may indicate a state in which the terminal device does not release an RRC after a random access procedure is completed. An RRC connection exists between the terminal device and a network device (for example, an access network device). In the RRC connected state, data transmission, such as downlink data transmission and/or uplink data transmission, may be performed between the terminal device and the network device. Alternatively, transmission of a data channel and/or control channel specific to the terminal device may be performed between the terminal device and the network device, to transmit specific information or unicast information of the terminal device.

In the RRC connected state, the network device may determine cell-level location information of the terminal device; that is, the network device may determine a cell to which the terminal device belongs. In the RRC connected state, when the terminal device moves, for example, moving from one cell to another, the network device may control the terminal device to perform cell handover (handover). It may be learned that mobility management of the terminal device in the RRC connected state may include cell handover. In addition, the mobility management of the terminal device in the RRC connected state may be controlled by the network device. Accordingly, the terminal device may be handed over to a designated cell in response to an instruction issued by the network device.

The RRC idle state indicates a state in which the terminal device camps on a cell but does not perform random access. The terminal device usually is the RRC idle state after being powered on or after an RRC release. In the RRC idle state, there is no RRC connection between the terminal device and the network device (for example, a network device camped on by the terminal device), the network device does not store a context of the terminal device, and no connection is established for the terminal device between the network device and a core network. If the terminal device is required to be switched to the RRC connected state from the RRC idle state, an RRC connection establishment process is initiated.

In the RRC idle state, the core network (CN) may transmit a paging message to the terminal device; that is, a paging process may be triggered by the CN. Optionally, a paging area may also be configured by the CN. In some cases, for a terminal device in an RRC idle state, when the terminal device moves (for example, moving from one cell to another), the terminal device may initiate a cell reselection (cell reselection) process. In some other cases, for a terminal device in an RRC idle state, when the terminal device is required to access a cell, the terminal device may initiate a cell selection (cell selection) process. In other words, mobility management of the terminal device in the RRC idle state may include cell reselection and/or cell selection.

The RRC inactive state indicates a state defined to reduce air interface signalling, quickly restore wireless connections, and quickly restore data services. The RRC inactive state indicates a state between the connected state and the idle state. The terminal device previously was in the RRC connected state and released the RRC connection with the network device, but the network device has stored the context of the terminal device. In addition, the connection established for the terminal device between the network device and the core network has not been released. In other words, a user plane bearer and a control plane bearer between the RAN and the CN are still maintained; that is, there is a CN-NR connection.

In the RRC inactive state, the RAN may transmit a paging message to the terminal device; that is, a paging process may be triggered by the RAN. An RAN-based paging area is managed by the RAN, and the network device can know that a location of the terminal device is at a level of the RAN-based paging area.

### NTN

In addition, 3GPP is currently studying NTN technologies. NTN generally provides a terrestrial user with communication services through satellite communication. The satellite communication has many unique advantages relative to terrestrial communication networks (such as a terrestrial cellular communication).

First, the satellite communication is not limited by a geographic location of a user. For example, a general terrestrial communication network cannot cover an area such as an ocean, a mountain, or a desert in which a network device cannot be set up. Alternatively, the terrestrial communication network does not cover some sparsely-populated areas. For the satellite communication, since one satellite may cover a relatively large terrestrial area, and the satellite may orbit the earth, theoretically, every location in the earth may be covered by a satellite communication network.

Second, the satellite communication has great social value. The satellite communication may cover remote mountainous areas, impoverished countries or regions at relatively low costs, thereby enabling people in these regions to enjoy advanced voice communication and mobile internet technologies. From this point of view, the satellite communication is conducive to narrowing a digital divide between these regions and developed regions and promoting development of these regions.

Third, the satellite communication has an advantage of long distance, and an increase in a communication distance does not significantly increase communication costs.

Finally, the satellite communication has high stability, and is not affected by natural disasters.

According to different orbital altitudes, communications satellites may be classified into a low-earth orbit (LEO) satellite, a medium-earth orbit (MEO) satellite, a geostationary earth orbit (GEO) satellite, a high elliptical orbit (HEO) satellite, and the like. At this stage, study on the LEO satellite and the GEO satellite is mainly conducted.

An altitude of the LEO satellite generally ranges from 500 km to 1500 km. Correspondingly, an orbital period of the LEO satellite is about 1.5 hours to 2 hours. For the LEO satellite, a signal propagation delay of single-hop communication between users is generally less than 20 ms. A maximum satellite visible time of the LEO satellite is about 20 minutes. The LEO satellite has advantages of a short signal propagation distance, a small link loss, and a low transmit power requirement for a terminal device of a user.

An orbital altitude of the GEO satellite is 35,786 km. A period for the GEO satellite to rotate around the earth is 24 hours. For the GEO satellite, a signal propagation delay of single-hop communication between users is generally about 250 ms.

To ensure satellite coverage and improve system capacity of an entire satellite communications system, the satellite generally covers a terrestrial area by using a plurality of beams. Therefore, one satellite may form dozens or even hundreds of beams to cover the terrestrial area. One beam of a satellite may cover a terrestrial area with a diameter of approximately tens to hundreds of kilometers.

### Timing Advance (TA)

In a wireless communications system (for example, an LTE/NR system), an orthogonal frequency division multiplexing (OFDM) transmission solution may be used. This is because the wireless communications system has good demodulation performance only if subcarriers keep orthogonality. However, due to a transmission delay, a downlink signal is received by a terminal device after a specific delay. Because different terminal devices have different locations relative to a network device, and uplink signals transmitted by different terminal devices arrive at the network device at different times, orthogonality of subcarriers is seriously affected and demodulation performance of the OFDM transmission solution is reduced.

Uplink transmission is used as an example. An important feature of the uplink transmission is orthogonal multiple access of different terminal devices in time and frequency domain, that is, uplink transmissions of different terminal devices in a same cell do not interfere with each other. The uplink transmission is generally transmission of multiple terminal devices. Therefore, the network device may simultaneously receive signals from a plurality of terminal devices.

In order to ensure orthogonality of uplink transmissions and avoid intra-cell (intra-cell) interference, the network device requires that times when signals, transmitted at a same instant by different terminal devices on different frequency domain resources, arrive at the network device should be substantially aligned with each other. This is because the network device can correctly decode the uplink data, as long as the network device receives, within a cyclic prefix range, uplink data transmitted by the terminal device. In addition, in order to maintain orthogonality between uplink reference signals that use different cyclic shifts, the network device also requires that received uplink reference signals should be time-aligned. Therefore, in order to implement uplink synchronization, or to ensure time synchronization on the network device side, a wireless communications system (for example, an LTE/NR system) may support a mechanism of uplink TA.

The TA may be understood as a command that is transmitted by the network device to the terminal device to adjust uplink transmission of the terminal device. The uplink transmission of the terminal device is not limited in embodiments of this application. For example, the uplink transmission may include one or more of the following: a physical uplink shared channel (PUSCH), a physical uplink control channel (PUCCH), a sounding reference signal (SRS), or the like.

In the communications system that supports uplink TA, an uplink clock and a downlink clock on a network device side are the same, there is an offset between an uplink clock and a downlink clock on a terminal device side, and different terminal devices have respective different uplink TA quantities. From a perspective of the terminal device, the TA quantity is essentially an offset between a start time of receiving a downlink frame and a time of transmitting an uplink frame by the terminal device. By appropriately controlling an offset of each terminal device, the network device may implement that times when uplink signals from different terminal devices arrive at the network device are substantially aligned with each other. Due to a relatively large transmission delay, a terminal device that is relatively far away from the network device transmits uplink data earlier than a terminal device that is relatively close to the network device.

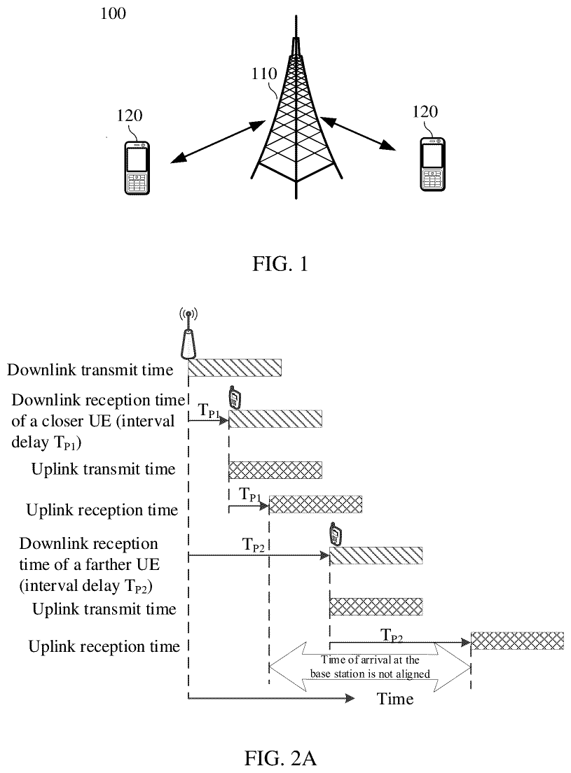

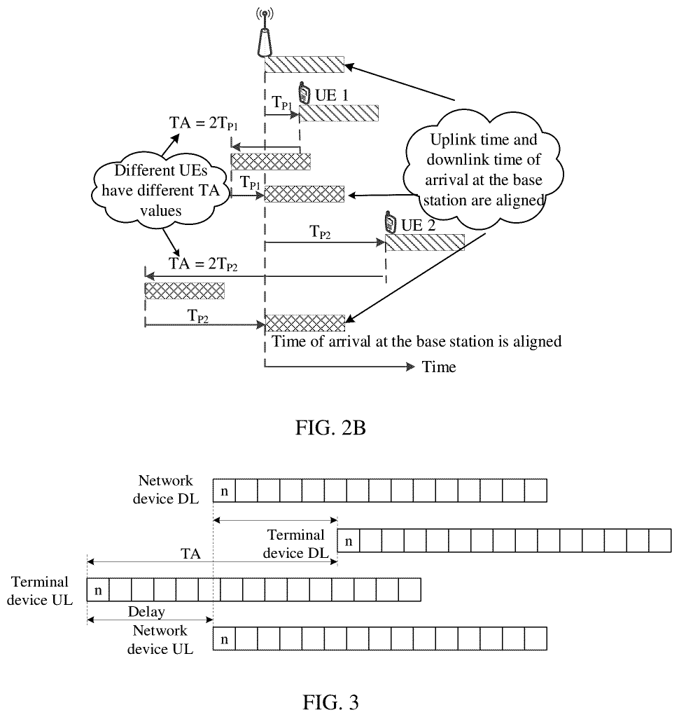

FIG. 2A and FIG. 2B respectively show a delay of arrival of an uplink signal to a network device in a case that there is no TA, and a delay of arrival of an uplink signal to a network device in a case that there is TA. As shown in FIG. 2A, in a case that there is no TA, uplink signals transmitted by different terminal devices (for example, terminal devices that have different distances from the network device) arrive at the network device at different times, which may result in intra-cell interference. Referring to FIG. 2B, after the TA is introduced, different terminal devices are configured with different uplink TAs, so that uplink signals transmitted by different terminal devices arrive at the network device at a same time, thereby facilitating avoiding intra-cell interference. For example, different terminal devices shown in FIG. 2B are respectively a terminal device 1 and a terminal device 2. If the terminal device 1 and the terminal device 2 receive a downlink signal and transmit an uplink signal in synchronization with each other, uplink signals transmitted by the terminal device 1 and the terminal device 2 are respectively offset from the network device by 2Tp1 and 2Tp2, thereby ensuring that the uplink signals from the terminal device 1 and the terminal device 2 reach the network device at a same time. In other words, if the terminal device 1 and the terminal device 2 receive a downlink signal and transmit an uplink signal in synchronization with each other, TA quantities corresponding to the terminal device 1 and the terminal device 2 are respectively 2Tp1 and 2Tp2, thereby ensuring that the uplink signals from the terminal device 1 and the terminal device 2 reach the network device at a same time.

The network device may determine a TA value of each terminal device by measuring uplink transmission of the terminal device. The network device may transmit a TA command to the terminal device to notify the terminal device of a TA value corresponding to the terminal device. For example, the network device may transmit the TA command to the terminal device in two manners, which are specifically as follows.

Manner 1: Acquisition of initial TA: The terminal device may implement initial uplink synchronization through a random access procedure. In the random access procedure, the network device may determine a TA value by measuring a received preamble (preamble), and transmit the TA value to the terminal device by using a TA command (TAC) field of a random access response (RAR) message. For example, the network device may carry a 12-bit TAC in the RAR message, to indicate the initial TA to the terminal device.

Manner 2: Adjustment of a radio resource control (RRC) connected state TA: Although in a random access procedure, the terminal device obtains uplink synchronization with the network device, timing when an uplink signal arrives at the network device may change with time. Therefore, the terminal device is required to continuously update an uplink TA quantity of the terminal device to maintain uplink synchronization. If TA of a terminal device is required to be corrected, the network device may transmit a TA command to the terminal device to instruct the terminal device to adjust uplink timing. In some implementations, the TA command is transmitted by the network device to the terminal device by using a medium access control control element (MAC CE). This MAC CE may also be referred to as a TA command MAC CE (namely, a MAC CE that carries a TA command). In other words, when the terminal device is in an RRC connected state, the terminal device may adjust uplink transmission based on the MAC CE that carries the TA command.

In a CA scenario, the terminal device may be required to use different TA values for different uplink carriers. Therefore, a timing advance group (TAG) is introduced in standards. The network device may configure a maximum of four TAGs for each cell group (cell group) of the terminal device, and configure, for each serving cell, a TAG associated with the service group. In some implementations, the terminal device may maintain TA for each TAG.

### Timing Relationship of an NR System

In a terrestrial communications system, a propagation delay of signal communication is generally less than 1 ms. In an NTN system, a communication distance between a terminal device and a satellite (or a network device) is very long, resulting in a high propagation delay of signal communication. For example, the propagation delay may range from tens of milliseconds to hundreds of milliseconds. A specific propagation delay is related to a satellite orbital height and a service type of satellite communication. To process the relatively high propagation delay, a timing relationship of the NTN system is required to be enhanced relative to that of an NR system.

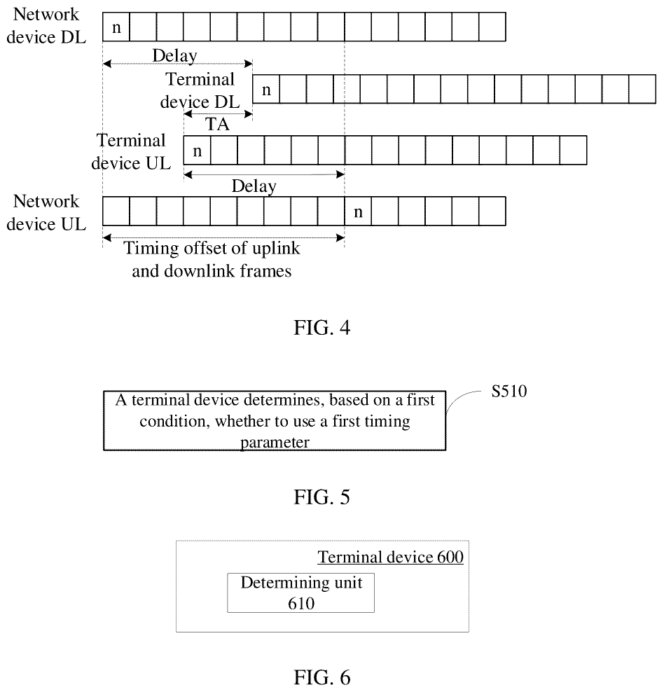

As in the NR system, in the NTN system, an impact of TA is also required to be considered when the terminal device performs uplink transmission. Because the propagation delay in the NTN system is relatively high, a range of TA values is relatively large. When the terminal device is scheduled to perform uplink transmission in a slot n, the terminal device may determine an uplink transmission timing (for example, transmission in advance during uplink transmission) based on a round-trip propagation delay, so that a signal arrives at a base station side on an uplink slot n of the base station side. Specifically, the timing relationship in the NTN system may include two cases, which are respectively shown in FIG. 3 and FIG. 4.

In one case, as in the NR system, a downlink slot and an uplink slot that are on a base station side in the NTN system are aligned with each other (a slot n shown in FIG. 3). In this case, to align uplink transmission of the terminal device with uplink and downlink slots on the base station side, the terminal device is required to use a relatively large TA value. During uplink transmission, a relatively large offset value, such as Koffset, is also required to be introduced.

In another case, unlike the NR system, there is an offset value (a timing offset of uplink and downlink frames shown in FIG. 4) between the downlink slot and the uplink slot on the base station side. In this case, to align the uplink transmission of the terminal device with the uplink slot on the base station side, the terminal device is required to use only a small TA value. However, in this case, the base station may require additional scheduling to process a corresponding scheduling timing sequence.

### Timing Sequence Relationship of an NR System

To ensure communication quality, a timing sequence relationship in an NR system is defined in a related technology. The following describes a physical downlink shared channel (PDSCH) receiving timing sequence, a PUSCH transmission timing sequence, a hybrid automatic repeat request-acknowledgement (HARQ-ACK) transmission timing sequence, a medium access control control element (MAC CE) activation timing sequence, a channel state information (CSI) transmission timing sequence, a CSI reference resource timing sequence, and an aperiodic sounding reference signal (SRS) transmission timing sequence.

The PDSCH receiving timing sequence is as follows: When a UE is scheduled by downlink control information (DCI) to receive a PDSCH, the DCI includes indication information of K₀, and K₀ is used to determine a slot for transmitting the PDSCH. For example, if the scheduling DCI is received in a slot n, a slot allocated for transmitting the PDSCH is a slot

$$⌊ n \cdot \frac{{2}^{{μ}_{PDSCH}}}{{2}^{{μ}_{PDCCH}}} ⌋ + {K}_{0} ,$$

where K₀ is determined based on a subcarrier spacing of the PDSCH, μ_{PDSCH} and μ_{PDCCH} are respectively used to determine subcarrier spacings configured for the PDSCH and a PDCCH. A value of K₀ ranges from 0 to 32.

A PUSCH transmission timing sequence based on DCI scheduling is as follows: When a UE is scheduled by DCI to transmit a PUSCH, the DCI includes indication information of K₂, and K₂ is used to determine a slot for transmitting the PUSCH. For example, if the scheduling DCI is received in a slot n, a slot allocated for transmitting the PUSCH is a slot

$$⌊ n \cdot \frac{{2}^{{μ}_{PDSCH}}}{{2}^{{μ}_{PDCCH}}} ⌋ + {K}_{2} ,$$

where K₂ is determined based on a subcarrier spacing of the PDSCH, μ_{PUSCH} and μ_{PDCCH} are respectively used to determine subcarrier spacings configured for the PUSCH and a PDCCH. A value of K₂ ranges from 0 to 32.

A PUSCH transmission timing sequence based on RAR grant (grant) scheduling is as follows: For a slot in which PUSCH transmission is scheduled by RAR grant, if an end location of a PDSCH that is received by a UE and that includes a corresponding RAR grant message is in a slot n after the UE initiates PRACH transmission, the UE transmits the PUSCH in a slot n+K₂+Δ, where K₂ and Δ are agreed upon by a protocol.

A transmission timing sequence for transmitting HARQ-ACK on a PUCCH is as follows: For a slot for transmitting a PUCCH, if an end location of reception of a PDSCH is in a slot n or an end location of reception of a PDCCH indicating release of a semi-persistent scheduling (Semi-Persistent Scheduling, SPS) PDSCH is in a slot n, a UE shall transmit corresponding HARQ-ACK information on a PUCCH resource in a slot n+K₁, where K₁ denotes a quantity of slots and is indicated by using an information field PDSCH-to-HARQ-timing-indicator in a DCI format, or is indicated by using a parameter dl-DataToUL-ACK parameter. K₁=0 indicates that the last slot for PUCCH transmission overlaps a slot for receiving a PDSCH or a slot receiving a PDCCH which indicating release of an SPS PDSCH.

The MAC CE activation timing sequence is as follows: When HARQ-ACK information corresponding to a PDSCH that includes a MAC CE command is transmitted in a slot n, a corresponding behavior indicated by the MAC CE command and downlink configuration assumed by a UE shall take effect from the first slot after a slot n+3Nₛₗₒₜ^{subframe,μ}, where Nₛₗₒₜ^{subframe,μ} indicates a quantity of slots included in each subframe in a subcarrier spacing configuration μ.

A CSI transmission timing sequence on a PUSCH is as follows: The CSI transmission timing sequence on a PUSCH is the same as a transmission timing sequence for PUSCH transmission generally scheduled by DCI.

The CSI reference resource timing sequence is as follows: CSI reference resources for reporting CSI in an uplink slot n′ are determined based on a single downlink slot n−n_{CSI_ref}, and

$$n = ⌊ {n}^{′} \cdot \frac{{2}^{{μ}_{DL}}}{{2}^{{μ}_{UL}}} ⌋ ,$$

where μ_{DL} and μ_{UL} respectively indicate a downlink subcarrier spacing configuration and an uplink subcarrier spacing configuration. A value of n_{CSI_ref} depends on a type for reporting the CSI.

The aperiodic SRS transmission timing sequence is as follows: If a UE receives, in a slot n, a transmission aperiodic SRS triggered by DCI, the UE transmits, in a slot

$$⌊ n \cdot {2}^{\frac{{μ}_{SRS}}{{{μ}_{PDCCH}}^{}}} ⌋ + k ,$$

the aperiodic SRS in each triggered SRS resource set, where k is configured by using a higher layer parameter slotOffset in each triggered SRS resource set, and is determined based on a subcarrier spacing corresponding to triggered SRS transmission, and μ_{SRS} and μ_{PDCCH} respectively indicate a subcarrier spacing configuration for the triggered SRS transmission and a subcarrier spacing configuration of a PDCCH that carries a triggering command.

### Timing Sequence Enhancement in an NR System

A PDSCH receiving timing sequence in the NR system is only affected by a downlink receiving timing sequence, and is not affected by a high transmission round-trip delay in the NTN system. Therefore, the PDSCH receiving timing sequence in the NR system may be reused in an NTN system.

For other timing sequences affected by interaction of downlink reception and uplink transmission, in order to work normally in the NTN system, or to avoid a high transmission delay in the NTN system, a timing sequence relationship is required to be enhanced. A simple solution is to introduce an offset parameter K_{offset} into the system and apply the parameter to a related timing sequence relationship. The following describes how to use the offset parameter.

A PUSCH (including CSI transmitted on the PUSCH) transmission timing sequence based on DCI scheduling is as follows: If the scheduling DCI is received in a slot n, a slot allocated for PUSCH transmission is a slot

$$⌊ n \cdot \frac{{2}^{{μ}_{PDSCH}}}{{2}^{{μ}_{PDCCH}}} ⌋ + {K}_{2} + {K}_{offset} .$$

A PUSCH transmission timing sequence based on RAR grant scheduling is as follows: For a slot in which PUSCH transmission is scheduled by RAR grant, a UE transmits the PUSCH in a slot n+K₂+Δ+K_{offset}.

A transmission timing sequence for transmitting HARQ-ACK on a PUCCH is as follows: For a slot for transmitting a PUCCH, a UE shall transmit corresponding HARQ-ACK information on a PUCCH resource in a slot n+K₁+K_{offset}.

A MAC CE activation timing sequence: When HARQ-ACK information corresponding to a PDSCH that includes a MAC CE command is transmitted in a slot n, a corresponding behavior indicated by the MAC CE command and downlink configuration assumed by a UE shall take effect from the first slot after a slot n+XNₛₗₒₜ^{subframe,μ}+K_{offset}, where X may be determined by a UE capability in NTN, and a value may not be 3.

A CSI reference resource timing sequence is as follows: CSI reference resources for reporting CSI in an uplink slot n′ are determined based on a single downlink slot n−n_{CSI}_{_{ref}}−K_{offset}.

The aperiodic SRS transmission timing sequence is as follows: If a UE receives, in a slot n, a transmission aperiodic SRS triggered by DCI, the UE transmits, in a slot

$$⌊ n \cdot \frac{{2}^{{μ}_{SRS}}}{{2}^{{μ}_{PDCCH}}} ⌋ + k + {K}_{offset} ,$$

the aperiodic SRS in each triggered SRS resource set.

An NTN cell system message may be used to broadcast a cell-level offset parameter, namely, a cell specific Koffset K_{cell,offset}. In addition, for a UE in a connected state, a network device may generally transmit, to the UE based on TA reported by the UE, a UE-specific offset parameter K_{UE,offset} carried in a Differential Koffset MAC CE, where the offset parameter may be used to indicate a difference between the offset parameter used by the UE and a cell-level offset parameter. In other words, Koffset used by the UE is K_{offset}=K_{cell,offset}−K_{UE,offset}. For example, for PUSCH transmission scheduled by a cell radio network temporary identifier (cell radio network temporary identifier, C-RNTI) PDCCH, a transmission timing sequence of the PUSCH is determined by using K_{offset}. In some other cases, such as PUSCH transmission scheduled by random access response (random access response, RAR) UL grant, the transmission timing sequence of the PUSCH may be determined by using K_{cell,offset}.

It may be learned that, in a case in which a cell-level offset parameter is broadcast in an NTN cell and a UE-specific offset parameter (for example, a Differential Koffset MAC CE) is transmitted, the UE in a connected state maintains both K_{cell,offset} and K_{offset}, which are used for determining a PUSCH transmission timing sequence in different scheduling scenarios. The Differential Koffset MAC CE is adjusted by the network device based on the TA reported by the UE. In other words, the network device adjusts K_{UE,offset} based on a difference between a TA value reported by the UE and a maximum TA value supported by the cell.

TA values of the terminal device in different cells may be different from each other, that is, offset parameters specific to the terminal device may be different from each other. Cell-level offset parameters of different cells may also be different from each other. How the terminal device determines validity of an offset parameter or how the terminal device uses an offset parameter becomes a problem to be resolved.

For example, in a handover process, a TA value of a UE in a target cell may be different from a TA value in a source cell, and a maximum TA value supported by the target cell may also be different from that supported by the source cell. Thus, in a handover process, how to determine validity of a specific offset parameter of the terminal device, or how to use an offset parameter becomes a problem to be resolved. If the terminal device continuously uses an offset parameter specific to the terminal device received from the source cell after the handover, a PUSCH transmission timing sequence in the target cell may fail. For example, Koffset calculated by using K_{UE,offset} received from the source cell and K_{cell,offset} broadcast by the target cell may be less than a TA value of the terminal device in the target cell, which may results in that a timing sequence of PUSCH transmission scheduled by a calculated C-RNTI PDCCH is unavailable.

To resolve the foregoing problem, an embodiment of this application provides a wireless communication method. In embodiments of this application, whether to use a first timing parameter is determined according to a first condition, which facilitates determining validity or a using method of an offset parameter.

FIG. 5 is a schematic flowchart of a wireless communication method according to an embodiment of this application. The following describes the method for wireless communication provided in an embodiment of this application with reference to FIG. 5.

Referring to FIG. 5, in step S510, a terminal device determines, based on a first condition, whether to use a first timing parameter.

The first timing parameter may be used to determine a timing sequence in a communication process, such as a receiving timing sequence and/or a transmission timing sequence. For example, the first timing parameter may be used to determine a PDSCH receive timing sequence, a PUSCH transmission timing sequence, a HARQ-ACK transmission timing sequence, a MAC CE activation timing sequence, a CSI transmission timing sequence, a CSI reference resource timing sequence, an SRS transmission timing sequence, and the like.

In some embodiments, the first timing parameter may be applied to an NTN system to enhance the NTN system. In other words, the first timing parameter may be used by the terminal device to communicate with a network device in the non-terrestrial network NTN.

In this case, the first timing parameter may be, for example, the offset parameter specific to the terminal device K_{UE,offset} described above, or for another example, K_{offset} described above.

As mentioned above, the offset parameter specific to the terminal device is adjusted based on a TA value. Generally, the terminal device further maintains a parameter associated with TA, such as N_{TA}. For example, N_{TA} may be maintained by using a TA command and a TA command MAC CE in a random access response. Therefore, in some embodiments, the first timing parameter may further be the parameter associated with TA.

It should be noted that the first timing parameter may include one or more of the foregoing: the offset parameter specific to the terminal device, the offset parameter K_{offset}; or the parameter associated with TA.

In some embodiments, the first timing parameter may be a timing parameter provided by a first cell. For example, the first cell may be a serving cell of the terminal device. In a cell handover scenario, the first cell may be, for another example, a source cell of the terminal device.

In the step S510, the terminal device not using the first timing parameter may include that the terminal device does not use the first timing parameter for communication. For example, another timing parameter is used for communication, that is, the first timing parameter becomes invalid. The terminal device using the first timing parameter may include that, the terminal device may determine a receiving or transmission timing sequence based on the first timing parameter during communication.

In different usage scenarios, the terminal device may determine, based on different first conditions, whether to use the first timing parameter, or determine validity of the first timing parameter.

In some embodiments, the first condition may be associated with one or more of the following: information associated with cell handover of the terminal device; an instant at which the first cell stops serving the terminal device; or a location of the terminal device.

In some embodiments, the first condition may be associated with the instant at which the first cell stops serving the terminal device. For example, when the first cell stops serving the terminal device, that is, when an instant at which the first cell stops serving the terminal device is reached, the terminal device does not use the first timing parameter, thereby facilitating avoiding an error in a communication timing sequence. Before the first cell stops serving, an instant at which the service stops is generally broadcast in a broadcast message. Therefore, the instant at which the first cell stops serving the terminal device may be generally determined based on a broadcast message of the first cell.

As described above, the terminal device may have different timing parameters in different cells. In a cell handover process, a timing parameter maintained by the terminal device may be a timing parameter of a target cell, or may be a timing parameter of a source cell. Therefore, for another example, the first condition may be related to the information associated with cell handover of the terminal device.

Generally, when the terminal device is handed over to the target cell, the terminal device cannot use a timing parameter of the source cell, so as to avoid a timing sequence error caused by a timing parameter error. Therefore, the first condition may include, for example, that the terminal device receives a handover command. The handover command mentioned herein may include an RRC reconfiguration message and/or a cell handover command. The RRC reconfiguration message may be, for example, an RRC reconfiguration message that includes reconfiguration WithSync (reconfigurationWithSync). The cell handover command may be, for example, a cell handover command MAC CE.

For another example, the first condition may include that random access of the terminal device is completed. As an example, for a cell handover based on a random access channel (random access channel), if the first condition is met, that is, the terminal device completes random access, the terminal device does not use the first timing parameter.

For another example, the first condition may include that the terminal device receives first information transmitted by the network device, where the first information is a message used for responding to completion of the handover. As an example, for a cell handover of RACH less, the terminal device may not perform a random access procedure. Therefore, if the first condition is met, that is, the first information transmitted by the network device is received by the terminal device, the terminal device does not use the first timing parameter. As another example, the first condition may also be applied to a random access-based cell handover. In other words, for the random access-based cell handover, after the first information transmitted by the network device is received by the terminal device, the terminal device does not use the first timing parameter.

For another example, the first condition may include that the terminal device is connected to a second cell. In other words, when the terminal device is connected to another cell different from the first cell, the terminal device does not use the first timing parameter provided by the first cell.

For another example, the first condition may include that the terminal device completes a handover from the first cell to a second cell. In other words, when the terminal device completes the handover from the first cell to the second cell, the terminal device does not use the first timing parameter provided by the first cell.

If the terminal device communicates with a network device in an NTN, a serving cell of the terminal device usually changes when a serving satellite of the terminal device is handed over. Therefore, when the serving satellite of the terminal device is handed over, the terminal device does not use the first timing parameter. Alternatively, when the terminal device is handed over from the first cell to the second cell, the terminal device does not use the first timing parameter, where a satellite corresponding to the first cell is different from a satellite corresponding to the second cell.

If the terminal device communicates with the network device in the NTN, a serving cell of the terminal device generally changes when a feeder link is handed over on a satellite connected to the terminal device, for example, switching from a gateway 1 to a gateway 2. Therefore, when the feeder link is handed over on the satellite connected to the terminal device, the terminal device does not use the first timing parameter. Alternatively, when the terminal device is handed over from the first cell to the second cell, the terminal device does not use the first timing parameter, where a feeder link of a satellite corresponding to the second cell is different from a feeder link of a satellite corresponding to the first cell.

In some embodiments, the first condition may be associated with the location of the terminal device.

For example, the first condition may be associated with an absolute location of the terminal device. As an example, when the absolute location of the terminal device is within coverage of the second cell, the terminal device may not use the first timing parameter.

For another example, the first condition may be associated with a distance between the terminal device and a reference point. As an example, the reference point may be a cell center of the first cell, so as to facilitate implementation. The reference point may alternatively be a cell edge of the first cell (for example, a point in the edge, close to the second cell, of the first cell).

As an example, if the first condition is associated with the distance between the terminal device and the reference point, the terminal device does not use the first timing parameter when it is determined that the distance between the terminal device and the reference point is greater than a preset threshold.

To improve reliability, the reference point may include a reference point of the first cell and a reference point of the second cell. When both the distance between the location of the terminal device and the reference point of the first cell and the distance between the location of the terminal device and the reference point of the second cell meet a requirement of the preset threshold, the terminal device does not use the first timing parameter.

The preset threshold may be determined according to a using scenario of the terminal device, which is not limited in this application.

It should be noted that the first condition may be any one of the first conditions, or may include a plurality of first conditions. For example, the first conditions may include that the terminal device receives a handover command and a distance between the location of the terminal device and a reference point meets a requirement of the preset threshold. For another example, the first condition may include that the terminal device receives the handover command and that the terminal device is connected to the second cell. When the first condition includes a plurality of conditions and the plurality of first conditions are all met, the terminal device does not use the first timing parameter, so as to improve reliability.

In some embodiments, the terminal device may further receive first indication information, such as first indication information transmitted by the network device, to determine whether the first timing parameter may be used or to determine a using scheme of a timing parameter. For example, the first indication information is used for indicating one or more of the following: a timing parameter used by the terminal device before cell handover; a timing parameter used by the terminal device in a cell handover process; or a timing parameter used by the terminal device after cell handover is completed.

In some embodiments, the first indication information may be carried in an RRC reconfiguration message or a cell handover command.

In some cases, when the terminal device switches from the first cell to the second cell, the terminal device may still use the first timing parameter. For example, for a cell handover in a same satellite and a same network device, TA of the terminal device remains unchanged, and a cell-level offset parameter may not change before and after the handover. Therefore, in this scenario, the terminal device may still use the timing parameter of the source cell. In other words, if the first cell and the second cell correspond to a same satellite and a same network device, the terminal device may still use the first timing parameter provided by the first cell when being handed over from the first cell to the second cell.

If a cell handover is performed in different satellites, that is, the first cell and the second cell correspond to different satellites, the terminal device does not use the first timing parameter.

Therefore, a solution for using the timing parameter of the terminal device in the foregoing two cases can be determined by using the first indication information, so as to ensure accuracy of a transmission timing sequence.

In addition, the timing parameter used by the terminal device is determined by using the first indication information, which is easy to be implemented, thereby being beneficial to reducing determining overheads of the terminal device.

In some embodiments, if the first timing parameter is carried in second information and when it is determined that the terminal device does not use the first timing parameter, an RRC layer of the terminal device instructs a lower layer, for example, a physical layer, to stop using information included in the second information. The first timing parameter being an offset parameter specific to the terminal device K_{UE,offset} is used as an example. The second information may be a Differential Koffset MAC CE. When the terminal device does not use the first timing parameter, the RRC layer of the terminal device may instruct the physical layer to stop using information included in the Differential Koffset MAC CE.

For example, the RRC layer of the terminal device may instruct the lower layer to stop using the information included in the second information, by using a synchronization reconfiguration message. For example, the following provides some operations in which the terminal device performs synchronization reconfiguration.
1> If access stratum (AS) security is not activated, perform actions upon going to RRC_IDLE as specified in 5.3.11 with the release cause “other” upon which the procedure ends (if the AS security is not activated, perform the actions upon going to RRC_IDLE as specified in 5.3.11 with the release cause ‘other’ upon which the procedure ends);
1> stop timer T430 if running (stop timer T430 if running);
. . .
2> if an NTN configuration message is configured for the target cell (if NTN-Config is configured for the target cell):
3> start timer T430 with a timer value set to ntn-UlSyncValidityDuration from a subframe indicated by epochTime, according to NTN configuration for the target cell (start timer T430 with the timer value set to ntn-UlSyncValidityDuration from the subframe indicated by epochTime, according to the target cell NTN-Config);
3> indicate lower layers to stop using/suspend/release the information regarding the Differential Koffset MAC CE (indicate to lower layers to stop using/suspend/release the information regarding the Differential Koffset MAC CE).

As mentioned above, the timing parameter Koffset used by a UE may be K_{offset}=K_{cell,offset}−K_{UE,offset}. In a related technology, it is defined that K_{cell,offset} in the formula is provided by a cell-level offset parameter (cellSpecifickoffset) and K_{UE,offset} is provided by Differential Koffset MAC CE signaling.

It may be learned from the foregoing analysis that the first timing parameter, such as a timing parameter specific to the terminal device, may be used in some cases, or may not be used in some cases. Therefore, to determine a using method of the first timing parameter, in some embodiments, the timing parameter used by the terminal device may be a timing parameter provided by a current serving cell. In other words, the terminal device communicates with the network device by using a second timing parameter, and the second timing parameter is provided by the current serving cell of the terminal device.

In other words, the timing parameter Koffset used by the UE may be K_{offset}=K_{cell,offset}−K_{UE,offset}, where K_{cell,offset} is provided by a cell-level offset parameter (cellSpecifickoffset), and K_{UE,offset} is provided by Differential Koffset MAC CE signaling of a serving cell.

In embodiments of this application, whether the first timing parameter is used in different scenarios is limited, thereby facilitates avoiding a transmission failure for the terminal device. For example, in a cell handover scenario, in embodiments of this application, a using method of a timing parameter provided by a source cell (namely, the first cell) is limited, thereby facilitates avoiding a PUSCH transmission timing failure of the terminal device in the target cell.

It should be noted that the second timing parameter may be the first timing parameter, or may be another timing parameter.

It should be noted that, the terminal device skipping using the first timing parameter mentioned above may be replaced with that the terminal device stops using, ignores, deletes, suspends, or terminates using the first timing parameter.

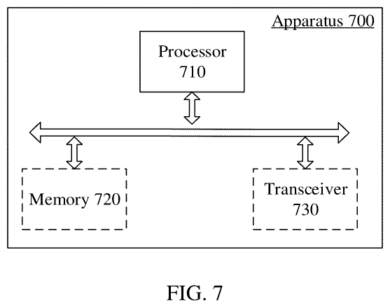

The methods embodiments of this application are described in detail above with reference to FIG. 1 to FIG. 5. The apparatus embodiments of this application are described in detail below with reference to FIG. 6 and FIG. 7. It should be understood that the description of the method embodiments corresponds to the description of the apparatus embodiments, and therefore, for parts that are not described in detail, one may refer to the foregoing method embodiments.

FIG. 6 is a schematic diagram of a terminal device according to an embodiment of this application. The terminal device shown in FIG. 6 includes a determining unit 610.

The determining unit 610 is configured to determine, based on a first condition, whether to use a first timing parameter, where the first timing parameter is a timing parameter provided by a first cell, and the first condition is associated with one or more of following: information associated with cell handover of the terminal device; an instant at which the first cell stops serving the terminal device; or a location of the terminal device.

In some embodiments, if the first condition is associated with the information associated with cell handover of the terminal device, the first condition includes one or more of the following: a handover command is received by the terminal device; random access of the terminal device is completed; first information transmitted by a network device is received by the terminal device; the terminal device is connected to a second cell; or the terminal device completes a handover from the first cell to a second cell, where the first information is a message for responding to completion of a handover.

In some embodiments, the handover command includes a radio resource control RRC reconfiguration message and/or a cell handover command.

In some embodiments, a satellite corresponding to the second cell is different from a satellite corresponding to the first cell.

In some embodiments, a feeder link of a satellite corresponding to the second cell is different from a feeder link of a satellite corresponding to the first cell.

In some embodiments, the first condition being associated with the location of the terminal device includes that: the first condition is associated with an absolute location of the terminal device, and/or the first condition is associated with a distance between the terminal device and a reference point.

In some embodiments, if the first condition is associated with the distance between the terminal device and the reference point, the terminal device determining, based on the first condition, whether to use a first timing parameter includes: when it is determined that the distance between the terminal device and the reference point is greater than a preset threshold, skipping, by the terminal device, using the first timing parameter.

In some embodiments, the reference point is a cell center of the first cell.

In some embodiments, the device further includes a receiving unit, configured to receive first indication information, where the first indication information is used for indicating one or more of the following: a timing parameter used by the terminal device before cell handover; a timing parameter used by the terminal device in a cell handover process; or a timing parameter used by the terminal device after cell handover is completed.

In some embodiments, the first indication information is carried in an RRC reconfiguration message or a cell handover command.

In some embodiments, the first timing parameter is carried in second information, and the device further includes: a notification unit, configured to: when it is determined that the terminal device does not use the first timing parameter, instruct, by an RRC layer of the terminal device, a bottom layer to stop using information included in the second information.

In some embodiments, the device further includes a communications unit, configured to communicate with a network device by using a second timing parameter, where the second timing parameter is provided by a current serving cell of the terminal device.

In some embodiments, the first timing parameter includes an offset parameter specific to the terminal device and/or a parameter associated with timing advance TA of the terminal device.

In some embodiments, the first timing parameter is used by the terminal device to communicate with a network device in a non-terrestrial network NTN.

FIG. 7 is a schematic diagram of a structure of a communications apparatus according to an embodiment of this application. Dashed lines in FIG. 7 indicate that the unit or module is optional. The apparatus 700 may be configured to implement the methods described in the foregoing method embodiments. The apparatus 700 may be a chip or a terminal device.

The apparatus 700 may include one or more processors 710. The processor 710 may support the apparatus 700 in implementing the methods described in the foregoing method embodiments. The processor 710 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application-specific integrated circuit, ASIC), a field-programmable gate array (field-programmable gate array, FPGA) or another programmable logic device, a discrete gate or transistor logic device, a discrete hardware component, or the like. The general-purpose processor may be a microprocessor, or the processor may be any conventional processor or the like.

The apparatus 700 may further include one or more memories 720. The memory 720 stores a program. The program may be executed by the processor 710, so that the processor 710 performs the methods described in the foregoing method embodiments. The memory 720 may be separate from the processor 710 or may be integrated into the processor 710.

The apparatus 700 may further include a transceiver 730. The processor 710 may communicate with another device or chip by using the transceiver 730. For example, the processor 710 may transmit data to and receive data from another device or chip by using the transceiver 730.

An embodiment of this application further provides a computer-readable storage medium, configured to store a program. The computer-readable storage medium may be applied to the terminal device provided in embodiments of this application, and the program causes a computer to perform the methods performed by the terminal device in various embodiments of this application.

An embodiment of this application further provides a computer program product. The computer program product includes a program. The computer program product may be applied to the terminal device provided in embodiments of this application, and the program causes a computer to perform the methods performed by the terminal device in various embodiments of this application.

An embodiment of this application further provides a computer program. The computer program may be applied to the terminal device provided in embodiments of this application, and the computer program causes a computer to perform the methods performed by the terminal device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and accompanying drawings of this application are used for distinguishing different objects from each other, rather than defining a specific order. In addition, the terms “include” and “have” and any variations thereof are intended to cover a non-exclusive inclusion.

In embodiments of this application, “indicate” mentioned herein may refer to a direct indication, or may refer to an indirect indication, or may mean that there is an association. For example, A indicates B, which may mean that A directly indicates B, for example, B may be obtained by means of A; or may mean that A indirectly indicates B, for example, A indicates C, and B may be obtained by means of C; or may mean that there is an association between A and B.

In embodiments of this application, “B corresponding to A” means that B is associated with A, and B may be determined based on A. However, it should be further understood that determining B based on A does not mean determining B based on only A, but instead B may be determined based on A and/or other information.

In embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, “predefined” or “pre-configured” may be implemented by pre-storing corresponding code, tables, or other forms that may be used to indicate related information in devices (for example, including a terminal device and a network device), and a specific implementation thereof is not limited in this application. For example, predefining may indicate being defined in a protocol.

In embodiments of this application, the “protocol” may indicate a standard protocol in the communications field, which may include, for example, an LTE protocol, an NR protocol, and a related protocol applied to a future communications system. This is not limited in this application.

In embodiments of this application, the term “and/or” is merely an association that describes associated objects, and represents that there may be three relationships. For example, A and/or B may represent three cases: only A exists, both A and B exist, and only B exists. In addition, the character “/” in the specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented as indirect couplings or communication connections through some interfaces, apparatuses or units, and may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL) manner or a wireless (such as infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by persons skilled in the art within the technical scope disclosed in this application shall fall within the protection scope of this application. Therefore, the protection scope of this application shall be subject to the protection scope of the claims.

What is claimed is:

1. A method for wireless communication, comprising:
determining, by a terminal device based on a first condition, not to use a first timing parameter, wherein the first timing parameter is a timing parameter provided by a first cell, and the first condition is associated with one or more of following:
information associated with cell handover of the terminal device;
an instant at which the first cell stops serving the terminal device; or
a location of the terminal device.

2. The method according to claim 1, wherein if the first condition is associated with the information associated with cell handover of the terminal device, the first condition comprises one or more of following:
the terminal device receives a handover command;
random access of the terminal device is completed;
first information transmitted by a network device is received by the terminal device;
the terminal device is connected to a second cell; or
the terminal device completes a handover from the first cell to a second cell,
wherein the first information is a message for responding to completion of a handover.

3. The method according to claim 2, wherein the handover command comprises a radio resource control RRC reconfiguration message and/or a cell handover command.

4. The method according to claim 2, wherein a satellite corresponding to the second cell is different from a satellite corresponding to the first cell.

5. The method according to claim 2, wherein a feeder link of a satellite corresponding to the second cell is different from a feeder link of a satellite corresponding to the first cell.

6. The method according to claim 1, wherein the first timing parameter comprises an offset parameter specific to the terminal device and/or a parameter associated with timing advance TA of the terminal device.

7. The method according to claim 1, wherein the first timing parameter is used by the terminal device to communicate with a network device in a non-terrestrial network NTN.

8. A terminal device, comprising a memory and a processor, wherein the memory is configured to store a computer program, and the processor is configured to execute the computer program to cause the terminal device to perform a method including:
determining, based on a first condition, not to use a first timing parameter, wherein the first timing parameter is a timing parameter provided by a first cell, and the first condition is associated with one or more of following:
information associated with cell handover of the terminal device;
an instant at which the first cell stops serving the terminal device; or
a location of the terminal device.

9. The device according to claim 8, wherein if the first condition is associated with the information associated with cell handover of the terminal device, the first condition comprises one or more of following:
a handover command is received by the terminal device;
random access of the terminal device is completed;
first information transmitted by a network device is received by the terminal device;
the terminal device is connected to a second cell; or
the terminal device completes a handover from the first cell to a second cell,
wherein the first information is a message for responding to completion of a handover.

10. The device according to claim 9, wherein the handover command comprises a radio resource control RRC reconfiguration message and/or a cell handover command.

11. The device according to claim 9, wherein a satellite corresponding to the second cell is different from a satellite corresponding to the first cell.

12. The device according to claim 9, wherein a feeder link of a satellite corresponding to the second cell is different from a feeder link of a satellite corresponding to the first cell.

13. The device according to claim 8, wherein the first timing parameter comprises an offset parameter specific to the terminal device and/or a parameter associated with timing advance TA of the terminal device.

14. The device according to claim 8, wherein the first timing parameter is used by the terminal device to communicate with a network device in a non-terrestrial network NTN.

15. A network device, comprising a memory and a processor, wherein the memory is configured to store a computer program, and the processor is configured to execute the computer program to cause the network device to perform a method including:
transmitting a first timing parameter, the first timing parameter being a timing parameter provided by a first cell;
wherein it is determined not to use the first timing parameter if a first condition is satisfied, and the first condition is associated with one or more of following:
information associated with cell handover of a terminal device;
an instant at which the first cell stops serving the terminal device; or
a location of the terminal device.

16. The terminal device according to claim 15, wherein if the first condition is associated with the information associated with cell handover of the terminal device, the first condition comprises one or more of following:
a handover command is received by the terminal device;
random access of the terminal device is completed;
first information transmitted by a network device is received by the terminal device;
the terminal device is connected to a second cell; or
the terminal device completes a handover from the first cell to a second cell,
wherein the first information is a message for responding to completion of a handover.

17. The network device according to claim 16, wherein the handover command comprises a radio resource control RRC reconfiguration message and/or a cell handover command.

18. The network device according to claim 16, wherein the handover command comprises a radio resource control RRC reconfiguration message and/or a cell handover command.

19. The network device according to claim 15, wherein the first timing parameter comprises an offset parameter specific to the terminal device and/or a parameter associated with timing advance TA of the terminal device.

20. The network device according to claim 15, wherein the first timing parameter is used by the terminal device to communicate with a network device in a non-terrestrial network NTN.
